(19) United States
(12) Patent Application Publication
(10) Pub. No.: US 2022/0277176 A1
(43) Pub. Date: Sep. 1, 2022

(54) LOG CLASSIFICATION USING MACHINE LEARNING

(71) Applicant: International Business Machines Corporation, Armonk, NY (US)

(72) Inventors: Aankur Bhatia, Bethpage, NY (US); HuyAnh Dinh Ngo, Sterling Heights, MI (US); Srinivas Babu Tummalapenta, Broomfield, CO (US); Mahbod Tavallaee, Markham (CA)

(21) Appl. No.: 17/187,137

(22) Filed: Feb. 26, 2021

(51) Int. Cl. G06K 9/62; G06N 3/08

(52) U.S. Cl. CPC G06K 9/6268; G06K 9/6262; G06K 9/6256; G06N 3/08

(57) ABSTRACT

Methods and a system of classifying unrecognized logs in an environment. The method includes inputting a log unrecognized during event collection into a machine learning model and predicting, by the machine learning model, a log source type of the log to allow for normalization of the log. The method also includes producing, by the machine learning model, a confidence score relating to the source type prediction, determining the confidence score exceeds a predetermined threshold, and submitting the log for normalization based on the log source type prediction. The method can also include predicting, by the machine learning model, an event name relating to the log, producing, by the machine learning model, a second confidence score relating to the event name prediction, determining the second confidence score exceeds another predetermined threshold, and submitting the log for normalization based on the identified log source type and the predicted event name.

### BACKGROUND

The present disclosure relates to log classification, and more specifically, to security log classification of unidentified logs.

A log is a collection of event records that include a collection of event fields that, together, describe a single event. An event can be a single occurrence within an environment, usually involving an attempted state change. An event can include a notion of time, the occurrence, and any details pertaining to the event or environment that may help explain the event's causes or effects. Log classification systems analyze logs to determine the type of information stored within the logs. For example, log classification can determine the application vendor, log type, application version, timestamp, protocols, event name, priority, and the like.

Managed security services provide a systematic approach to managing an organization's security. Functions of a managed security service include round-the-clock monitoring and management of intrusion detection systems and firewalls, overseeing patch management and upgrades, performing security assessments and security audits, and responding to security emergencies. Managed security services can perform some of these functions by analyzing the logs of an environment to detect and prevent security risks.

### SUMMARY

Embodiments of the present disclosure include a computer-implemented method of classifying unrecognized logs. The computer-implemented method includes inputting a log unrecognized during event collection into a machine learning model and predicting, by the machine learning model, a log source type of the log to allow for normalization of the log. The computer-implemented method also includes predicting, by the machine learning model, a confidence score relating to the log source type prediction, determining the confidence score exceeds a predetermined threshold and submitting the log for normalization based on the predicted log source type. The computer-implemented method can also include predicting, by the machine learning model, an event name relating to the unrecognized log, predicting, by the machine learning model, a second confidence score relating to the event name prediction, determining the second confidence score exceeds another predetermined threshold, and submitting the log for normalization based on the identified log source type and the predicted event name.

Embodiments of the present disclosure include a computer-implemented method of training a convolutional neural network to classify unrecognized logs. The computer-implemented method includes selecting a plurality of historical logs from a log storage. The historical logs are previously known logs stored by a log collector or log management system. The computer-implemented method also includes preprocessing the historical logs into a labeled dataset for a convolutional neural network, separating the labeled dataset into a training dataset and a validation dataset, training the convolutional neural network with the training dataset to output log source types for logs, including confidence scores relating to the log source types, and validating log source type predictions made by the convolutional neural network using the validation dataset. Additionally, the convolutional neural network can a six-layer network including three convolutional neural network (CNN) layers and two fully-connected layers, wherein the three CNN layers can each include both one-dimensional convolutions and sub-sampling pooling.

Further embodiments are directed to a system of classifying unrecognized logs and configured to perform the methods described above. The present summary is not intended to illustrate each aspect of, every implementation of, and/or every embodiment of the present disclosure.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a log classification system, in accordance with embodiments of the present disclosure.

FIG. 2 is a flow diagram illustrating a process of classifying unrecognized logs, in accordance with embodiments of the present disclosure.

FIG. 3 is a flow diagram illustrating a process of training a convolutional neural network to classify unrecognized logs, in accordance with embodiments of the present disclosure.

FIG. 4 is a high-level block diagram illustrating an example computer system that may be used in implementing one or more of the methods, tools, and modules, and any related functions, described herein, in accordance with embodiments of the present disclosure.

FIG. 5 depicts a cloud computing environment, in accordance with embodiments of the present disclosure.

FIG. 6 depicts abstraction model layers, in accordance with embodiments of the present disclosure.

While the present disclosure is amenable to various modifications and alternative forms, specifics thereof have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to log classification, and more specifically, to log classification of unrecognized logs. While the present disclosure is not necessarily limited to such applications, various aspects of the disclosure may be appreciated through a discussion of various examples using this context.

A log can be viewed as a collection of event records for a single event or related events. An event can be a single occurrence within an environment, usually involving an attempted state change. Events can include a time, an occurrence, and any details that pertain to the event or environment that explain the causes and effects of the event. An event field can describe one characteristic of an event. For example, event fields can be a date, time, source, internet protocol (IP) address, user identification, host identification, and the like. An event record is a collection of event fields that, when taken together, describe a single event.

The logs generated for an environment can be evaluated during an audit to assess the overall status of the environment as well as to identify any potentially problematic activity. For example, security logs can reflect security incidents of one or more security events that can indicate a breach in security. Security logs can also indicate unauthorized access to a system, theft of information, denial of service, as well as organization-specific activities that may be prohibited.

Security logging is typically focused on detecting and responding to attacks, malware infection, data theft, and other security-related issues. For example, a security log can reflect a record of user authentication and other access decisions with the purpose of analyzing whether that login has access to a resource without proper authorization. It should be noted that while the present disclosure primarily discusses security logs, the disclosure is not necessarily limited to security logs. For example, other logging such as operational logging, compliance logging, application debug logging, and the like can also be used.

Organizations can use log management systems to collect and analyze logs. These systems can provide flat-file searching, centralized log collection, compliance-specific reporting, and real-time alerting. Log management systems are also capable of using a correlation of capabilities on the system to correlate aggregated logs to specific offenses, which can be analyzed by an analyst. For example, security logs can be analyzed using a static rule-based approach to normalize all vendor security events into a common log object. Additionally, organizations can customize and tune solutions specific to their environment and needs.

Log management system services include data collection, data normalization, data event taxonomy, data storage, data forwarding, and the like. Data collection can include monitoring incoming data and filtering/parsing log messages that are relevant to the system. Once collected, the logs are normalized. In this step, the raw log data is mapped to its various elements (e.g., source, destination IP address, protocol, priority, contextual data, etc.) Additionally, normalization also categorizes the log resulting in a log message that is a more meaningful piece of information. For example, a log may have a four-digit error code in a log message. This error code, which may be vendor-specific, and can indicate a login failure. During normalization, the error code can be normalized into a word indicating the login failure so as to allow easier analysis of the log.

Limitations on log management remain, however, as the process of parsing logs can fail, resulting in numerous logs not being analyzed. There are numerous causes of log parsing failures. For example, log parsing failure can be caused by user error during the deployment of a component when the user enters incorrect information into the schema, device configuration change such as when a customer device gets upgraded or changed to a different vendor resulting in a different log, and the like. These causes can result in logs that go unparsed. The result is that the log is never analyzed for potential issues, and the data is unseen.

Additionally, vendors typically do not use a standardized log message format when generating their respective logs. Thus, each log requires analysis to determine the vendor and which normalization schema to use. For example, Cisco's® log message format is different from VMware's®, which is different from NETGEAR's®, and so on, regardless of how the vendor transports the underlying log. If logs are not parsed and normalized, then information regarding an event may be missing resulting in potential issues going undetected.

Embodiments of the present disclosure may overcome the above and other problems by using a log classification system that predicts log source types and event names of unrecognized logs. The log classification system can be deployed as a machine learning prediction endpoint comprising a machine learning model that predicts the log source types and also producing a confidence score for the log source type prediction. In some embodiments, the log classification system uses a machine learning model to additionally predict an event name of a log. The prediction can also produce a second confidence score similar to that of the log source type prediction. For example, an unrecognized log can be analyzed by the log classification system to determine that the log source type is a Cisco log and that the event name captured by the log is that of authentication success. Each of these predictions can be accompanied by a confidence score indicating how accurate the log classification system believes the prediction to be.

More specifically, the log classification system can use a one-dimensional convolutional neural network trained with previously known log events to predict the log source type and event type of an unrecognized log. During training, the log classification system can parse, clean, and tokenize the log data using natural language processing techniques. The tokenized log events can then be padded and converted into word vectors using various tokenization techniques. The tokenized words can then be embedded using various embedding techniques. The embedded tokenized words can then be used to train a convolutional neural network to predict log source types and event types of unrecognized logs.

In some embodiments, the convolutional neural network includes corresponding confidence scores relating to the log source type and event name predictions, respectively. For example, the convolution neural network can predict a raw log file has a log source type of “CheckPoint” and that prediction can have a confidence score of “99.85%”. During each training cycle, the convolutional neural network is trained to improve its confidence scores for the log source type and event name predictions. The training can continue until the confidence scores reach a predetermined threshold or after a number of training cycles have been performed.

In some embodiments, the convolutional neural network (CNN) is a one-dimensional six-layer network including three CNN layers and two fully-connected layers. The three CNN layers can each include one-dimensional convolutions and sub-sampling “pooling”. For example, upon receiving an input, the CNN layers can perform a sequence of convolutions, the sum of which is passed through an activation function, followed by a sub-sampling operation. The layers can process the input and learn to extract features that can be used in the classification task by the two fully-connected layers. The additional layers can then process the data and learn to extract such features, which are used in the log classification task performed by the fully-connected layers. Thus, both feature extraction and classification operations are fused into one process that can be optimized during the training process.

In some embodiments, the log classification system uses historical logs stored by a log management system to train the convolutional neural network. The historical logs can be previously known logs by a log collector or log management system that have been previously classified and normalized. The historical logs can be organized based on various features such as vendor type, event type, configuration, and the like.

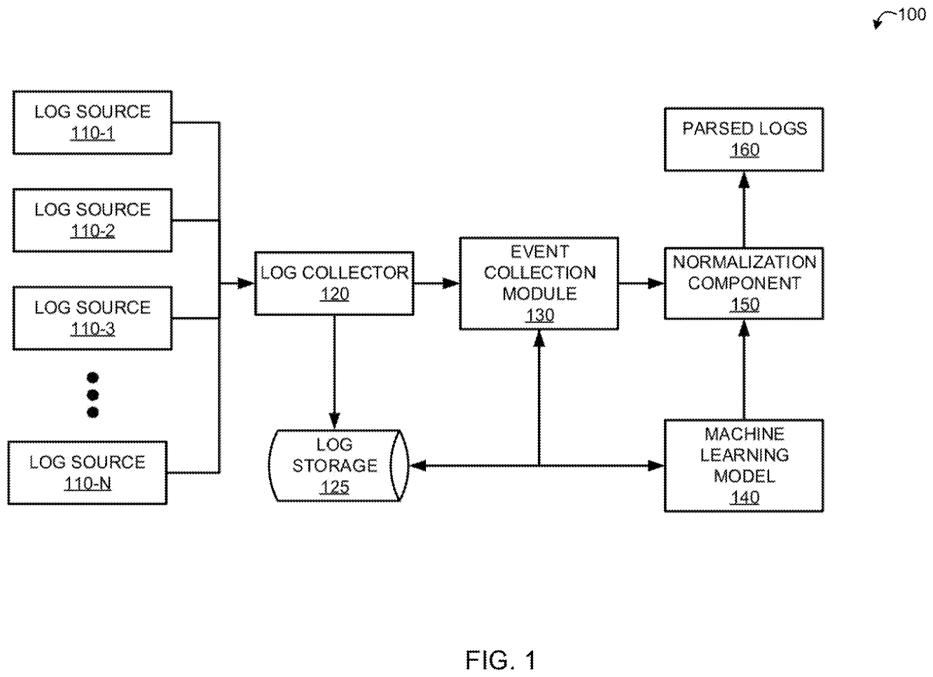

Referring now to FIG. 1, shown is a high-level block diagram of a log classification system 100 of log classification of unrecognized logs, in accordance with embodiments of the present disclosure. The log classification system 100 includes a log source 110-1, 110-2, 110-3, 110-N (collectively “log sources 110”) where N is a variable integer representing any number of possible log sources 110, a log collector 120, a log storage 125, an event collection module 130, a machine learning model 140, a normalization component 150, and parsed logs 160.

The log sources 110 are components of the log classification system 100 configured to produce raw logs. The log sources 110 can be push-based or pull-based sources. With push-based log sources 110, the device or application emits a log that is received by the log collector 120. The transmission can be locally or over a network. Examples of push-based log sources 110 include, but are not limited to, Syslog, SNMP, and the Windows Event Log. Pull-based log sources 110 have an application or mechanism that pulls the logs from the log source 110. Typically, systems that operate in this manner store their log data in a proprietary format. For example, Checkpoint uses the OPSEC C library that developers can use to pull the logs, while other vendors use databases such as SQL, Oracle, MySQL, and the like.

In regard to logs, a log can be viewed as a collection of event records for a single event or related events. An event can be a single occurrence within an environment, usually involving an attempted state change. Events can include a time, an occurrence, and any details that pertain to the event or environment that explain the causes and effects of the event. An event field can describe one characteristic of an event. For example, event fields can be a date, time, source, internet protocol (IP) address, user identification, host identification, and the like. An event record is a collection of event fields that, when taken together, describe a single event.

The logs, such as security logs, can be used as all or part of an audit, which is a process of evaluating logs within an environment. An audit can assess the overall status or identify any notable or problematic activity. Log sources 110 that produce these logs include, for example, systems, user applications, servers operating system components, networking components, network infrastructure components, and the like. When performing an audit, an alert or alarm can be produced, which is an action taken in response to an event, usually intended to notify an administrator or someone monitoring the environment.

Logs can be additionally classified based on the information provided in the logs. For example, logging can involve security logging, operational logging, compliance logging, application debug logging, and the like. Security logging, for instance, can be primarily focused on detecting and responding to potential attacks, malware infection, data theft, and other security-related issues.

The log sources 110 can also produce the logs using various forms of syntax and format that can be vendor-specific. The syntax and format of a log can define how log messages are formed, transported, stored, reviewed, and analyzed. For example, an event record could be a text string where the event collection module 130 can perform a text search on the log to identify the event record. However, this method relies on log messages remaining consistent. If a change in the format occurs, then the event collection module 130 may not be able to identify an event record or event name. Typical log formats include, for example, W3C Extended Log File Format (ELF), Apache access log, Cisco SDEE/CIDEE, ArcSight common event format (CEF), Syslog, IDMEF, and the like. However, most logs do not follow a specific or predetermined format and can be considered as free-form text.

Regarding syntax, every log includes syntax that can contain a subject, a predicate, as well as complements and attributes. The syntax primarily involves how the log is structured and what words are used to convey the message. The structure can include fields such as date/time, event name, type of log entry, system type, application or component that produced the log, a success/failure indicator, severity, priority, or importance of a log message, user-related activities, and the like.

The log collector 120 is a component of the log classification system 100 configured to receive and collect logs from the log sources 110. Once collected, the log collector 120 can also store the logs in the log storage 125. The log collector 120 can be part of a larger log management service that provides log collection, centralized log aggregation, long-term log storage, and retention, log rotation, log analysis, and log search and reporting.

The log storage 125 is a component of the log classification system 100 configured to store historical logs produced by an environment. The logs retained in the log storage 125 can be based on a log retention policy that can consider applicable compliance requirements, risk posture, log sources 110, sizes of the logs generated, available storage options, and the like. The log storage 125 is further configured to store text-based log files, binary log files, and compressed log files. The log storage 125 can be a database that stores the logs, a Hadoop log storage, cloud-based storage, or any combination thereof.

In some embodiments, the log storage 125 is within a storage environment configured to consolidate, manage, and operate data storage. The storage environment can be a server or an aggregation of servers. Examples of the storage environment include storage servers (e.g., block-based storage), direct-attached storage, file servers, server-attached storage, network-attached storage, or any other storage solution. In some embodiments, the components of the storage environment are implemented within a single device. In some other embodiments, the components of the storage environment include a distributed architecture. For example, the storage environment can include multiple storage systems physically located at different locations but are able to communicate over a communication network to achieve the desired result.

In some embodiments, the log storage 125 is communicatively coupled to the log collector 120 and the machine learning model 140 via a network. Embodiments of the network include a local-area network, wireless network, the Internet, public switch telephone network, a radio access network, as well as other types of available networks. Other networks include wired or wireless communication networks operating within an environment.

The event collection module 130 is a component of the log classification system 100 configured to categorize logs. For example, for security logs, the event collection module 130 can divide logs into categories such as change management, authentication and authorization, data and system access, threat management, performance and capacity management, miscellaneous errors and failures, miscellaneous debugging messages, and the like. Additionally, the event collection module 130 can determine the log source type and event name of a log using conventional techniques such as parsers or by comparing the logs to known device configurations. In the event that the event collection module 130 is unable to determine the log source type or the event name of the log, it can send the log to the machine learning model 140 for further evaluation. Otherwise, the identified log can be transmitted to the normalization component 150 for parsing and normalization.

The machine learning model 140 is a component of the log classification system 100 configured to classify unidentified logs by determining log source types and event names of logs. The machine learning model 140 can be trained using historical logs converted into training data. The log source type predictions and the event name predictions can be accompanied by confidence scores the machine learning model 140 has in make those respective predictions. For example, the machine learning model 140 can predict that a log has a “Cisco” log source type. Accompanying that prediction can be a confidence score of “95.35%”. The confidence score can reflect the machine learning model's 140 confidence in the log source type prediction. An administrator can utilize that confidence score to either allow the normalization component 150 to normalize the log based on the prediction or can decide that the confidence score is too low and can use other means to evaluate the log.

The machine learning model 140 can be trained with a training dataset generated from the historical logs stored in the log storage 125. For example, the training samples can include parameters such as log source type, event name, configuration, date/time, system, application priority, and the like. Additionally, the training samples can include the syntax used by the historical logs that provide a structure as to the information contained within the historical logs.

The machine learning model 140 can employ various machine learning techniques in determining a log source type and event name of an unrecognized log. Machine learning techniques can include algorithms or models that are generated by performing supervised training on a dataset and subsequently applying the generated algorithm or model to generate the log source type prediction and/or event name prediction of the unrecognized log. Machine learning algorithms can include but are not limited to decision tree learning, association rule learning, artificial neural networks, deep learning, inductive logic programming, support vector machines, clustering, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), hidden Markov models, Gaussian naïve Bayes, multinomial naïve Bayes, averaged one-dependence estimators (AODE), Bayesian network (BN), classification and regression tree (CART), feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

In some embodiments, the machine learning model 140 is a one-dimensional convolutional neural network with a configuration of three CNN layers and two fully-connected layers. The three CNN layers can each include both one-dimensional convolutions and sub-sampling “pooling”. For example, upon receiving an input, the CNN layers can perform a sequence of convolutions, the sum of which is passed through an activation function, followed by a sub-sampling operation. The layers can process the input and learn to extract features that can be used in the classification task by the two fully-connected layers. The fully-connected layers can be identical to the layers of a typical Multi-layer Perceptron (MLP) and are often referred to as “MLP-layers” or “dense layers”. The output of the convolutional neural network can include the log source type predictions, the event name predictions, and confidence scores for logs inputted into the network.

In some embodiments, the one-dimensional convolutional neural network is determined by a configuration of several hyper-parameters. These hyper-parameters include, but are not limited to, the number of hidden CNN or MLP layers/neurons, the filter (kernel) size in each CNN layer, a subsampling factor in each CNN layer, and the choice of pooling and activation operators. For example, as described above, the machine learning model 140 can be a one-dimensional convolutional neural network with three CNN layers, two fully-connected or MLP layers, and maxpooling as the choice of pooling operator.

One-dimension convolutional neural networks can effectively produce predictions on applications that have a limited labeled dataset and high variations acquired from different sources (e.g., logs acquired from different log sources 110). The CNN layers can process raw one-dimensional data (e.g., text preprocessed from the logs) and learn to extract such features that can be used in the classification task (e.g., log source type prediction and event name prediction) performed by the MLP layers. One-dimensional convolutional neural networks can also provide a low computational complexity since the only costly operation is a sequence of one-dimensional convolutions that can be linear weighted sums of two one-dimensional arrays.

The normalization component 150 is a component of the log classification system 100 configured to normalize and parse logs received from the log sources 110. The normalization process can take raw log data and map its various elements (e.g., source, destination IP, severity, date, time, etc.) to a common format. The result of the normalization process allows the log information to be analyzed to determine whether the event captured by the log(s) requires any action. For example, a log message may provide a code such as “ID=6856”, the normalization component 150 can utilize parsers based on the log's log source type and/or event name to normalize the code into a string of characters indicating a login failure.

Normalizing a raw log can require that the normalization component 150 receive documentation relating to the log that details as to the description of the raw log, the syntax of the log, and what each field contains. The documentation can be log source types and/or event names relating to the logs generated by either the event collection module 130 or the machine learning model 140. Once the documentation is analyzed, the normalization component 150 can select the appropriate parser with the proper parsing expressions to normalize the fields within the raw log. These fields include, for example, source and destination IP addresses, source and destination ports, taxonomy, timestamps, user information, and priority. Typically, a regular expression implementation is used to parse the data. Once parsed, the parsed log 160 can be sent for correlation and analysis.

It is noted that FIG. 1 is intended to depict the major representative components of an exemplary log classification system 100. In some embodiments, however, individual components may have greater or lesser complexity than as represented in FIG. 1, components other than or in addition to those shown in FIG. 1 may be present, and the number, type, and configuration of such components may vary.

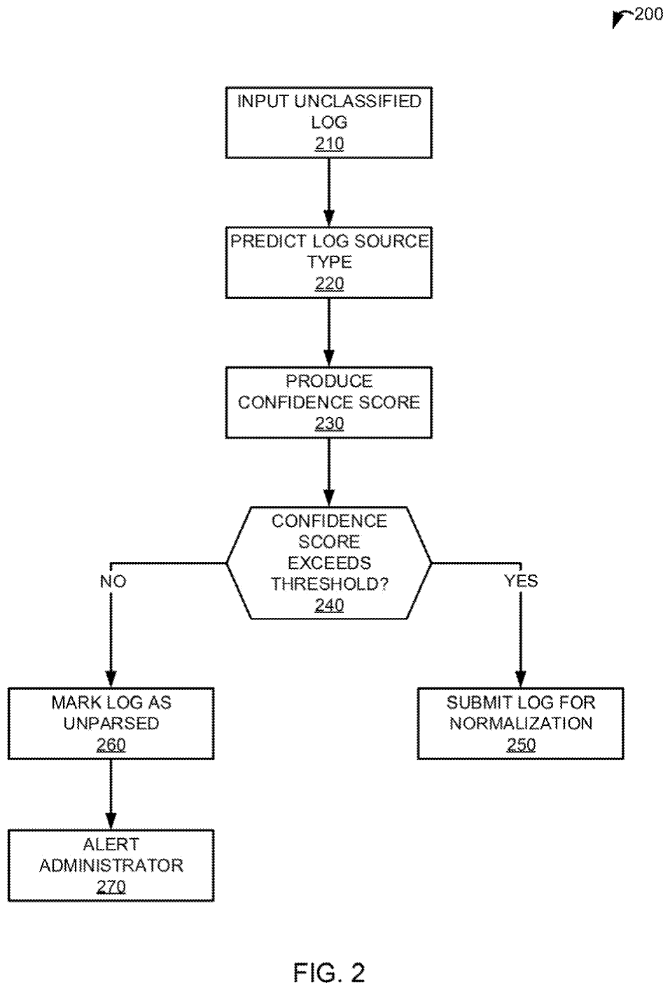

FIG. 2 is a flow diagram illustrating a process 200 of classifying unrecognized logs using a machine learning model 140, in accordance with embodiments of the present disclosure. The process 200 may be performed by hardware, firmware, software executing on a processor, or a combination thereof. For example, any or all the steps of the process 200 may be performed by one or more processors embedded in a computing device.

The process 200 begins by inputting an unrecognized log into the machine learning model 140. This is illustrated at step 210. The unclassified log can be a raw log that the event collection module 130 is unable to recognize. The log may be unrecognizable due to changes to the log, such as a device configuration change, a log format change, a device upgrade, a new log source type 110, and the like.

The machine learning model 140 predicts a log source type of the unrecognized log. This is illustrated at step 220. In some embodiments, the machine learning model 140 also predicts an event name of the unclassified log. The log source type predictions and the event name predictions can be accompanied by confidence scores the machine learning model 140 has in make those respective predictions. For example, the machine learning model 140 can predict that a log has a “Cisco” log source type. Accompanying that prediction can be a confidence score of “95.35%”. The confidence score can reflect the machine learning model's 140 confidence in the log source type prediction.

In some embodiments, the machine learning model 140 is a one-dimensional convolutional neural network that performs the predictions on the unclassified log. The one-dimensional convolutional neural network can be configured with three CNN layers and two fully-connected layers. The three CNN layers can each include both one-dimensional convolutions and sub-sampling “pooling” occur. For example, upon receiving an input, the CNN layers can perform a sequence of convolutions, the sum of which is passed through an activation function, followed by a sub-sampling operation. The layers can process the input and learn to extract features that can be used in the classification task by the two fully-connected layers. The two fully-connected layers can then produce the log source type prediction and the event name prediction.

The machine learning model 140 produces a confidence score relating to the log source type prediction. This is illustrated at step 230. The confidence score can reflect a decimal number between zero and one interpreting a percentage of confidence of the log source type prediction. For example, the confidence score can be produced as a range from 0% to 100%, with 100% being an absolute certainty for a given log source type prediction. While typically shown as a percentage, the confidence score can vary based on the accuracy, recall, precession, and preference requested. In some embodiments, the confidence score can be produced as a set of expressions. For example, the set of expressions be expressions such as “low”, “medium”, and “high”.

In some embodiments, the machine learning model 140 produces a confidence score relating to the event name prediction. The confidence score can reflect a decimal number between zero and one interpreting a percentage of confidence of the event name prediction. For example, the confidence score can be produced as a range from 0% to 100%, with 100% being an absolute certainty for a given event name type prediction.

A determination is made whether the confidence score of the log source type exceeds a predetermined threshold. This is illustrated at step 240. The predetermined threshold is set by an administrator to allow for the normalization of the log based on the confidence score achieving the predetermined threshold. The predetermined threshold may represent a percentage the confidence score must achieve in order for the log source type prediction to be used for normalization purposes. For example, the predetermined threshold may be set at 90% where the log source type prediction must exceed that percentage or be marked as unparsed. If the log source type prediction exceeds that percentage the log source type prediction can be used by the normalization component 150 to select the corresponding parsers. This is illustrated at step 250.

Upon determining the log source type prediction does not exceed the predetermined threshold, the log classification system 100 can mark the unclassified log as unparsed. This is illustrated at step 260. The mark can indicate that further review of the log may be required in order for the normalization process to occur. Once marked, the log classification system 100 can alert an administrator that a log is unable to be normalized due to the event collection module 130 and the machine learning model 140 being unable to sufficiently classify the log. This is illustrated at step 270.

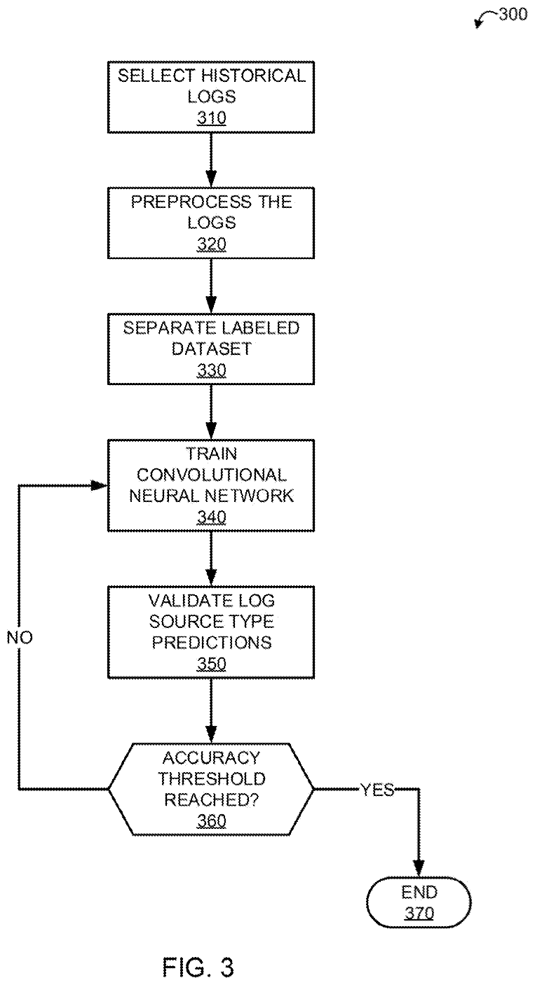

FIG. 3 is a flow diagram illustrating a process 300 of training the machine learning model 140. The process 300 may be performed by hardware, firmware, software executing on a processor, or a combination thereof. For example, any or all the steps of the process 300 may be performed by one or more processors embedded in a computing device.

The process 300 begins by selecting historical logs from the log storage 125 that are going to be used to train the machine learning model 140. These historical logs can be logs that may have been previously known logs stored by the log collector 120. The historical logs can be selected based on the type of monitoring being performed. For example, the historical logs may be security-related logs. The security logs can include logs such as network infrastructure logs and security host logs. These logs can reflect events such as logins and logouts, connection established to a service, byte transferred during connection, configuration changes, changes to executable files, probe detection, and the like.

The historical logs are preprocessed into a labeled dataset. This is illustrated at step 320. In some embodiments, the historical logs are preprocessed such that they can be used as training data for the one-dimensional convolutional neural network. Preprocessing the historical logs can include cleaning, or parsing, each of the historical logs into separate detectable words located within the historical logs. In some embodiments, the cleaning is performed using natural language processing to detect and parse individual words detected within a log. Once cleaned, each word is tokenized and separated from the other words detected. Each separated word can then be converted into a number. The number corresponding to the word will only correspond to that word. For example, the word “port” can be assigned the number “4”. Every time “port” is detected, the number “4” will be used. No other number will use the number “4” as that number now corresponds to the word “port”.

The preprocessing process can also include padding each number such that all of the number assigned to words have an equal byte length. As such, each number will have the same number of bytes by padding the corresponding bytes of a number with zeroes. Once padded, the numbers can then be converted into word vectors. In some embodiments, the numbers are converted into word vectors using various tensor flow tokenization techniques.

The processed logs are separated into a training dataset and a validation dataset. This is illustrated at step 330. The training dataset can be used to train the machine learning model 140, and the validation dataset can be used to validate the accuracy of the machine learning model 140. The training dataset is used to train the machine learning model 140. This is illustrated at step 340. In some embodiments, the machine learning model 140 as a one-dimensional convolutional neural network that is trained using the training dataset. The convolutional neural network can be trained to predict a log source type and/or an event name of an unclassified log. The one-dimensional convolutional neural network can be configured with three CNN layers and two fully-connected layers. The three CNN layers can each include both one-dimensional convolutions and sub-sampling “pooling”. For example, upon receiving an input, the CNN layers can perform a sequence of convolutions, the sum of which is passed through an activation function, followed by a sub-sampling operation. The layers can process the input and learn to extract features that can be used in the classification task by the two fully-connected layers. The two fully-connected layers can then produce the log source type prediction and the event name prediction.

A sample from the validation dataset is be inputted into the machine learning model 140 after a number of training cycles to validate the machine learning model 140. This is illustrated at step 350. The output produced can be analyzed to determine whether the machine learning model 140 correctly predicted the log source type and/or the event name of the log.

A determination is made as to whether the accuracy of the machine learning model 140 exceeds a predetermined threshold. This is illustrated at step 360. For example, if the machine learning model 140 accurately predicts the log source type of the logs in the validation set 95% of the time, and the threshold was set at 90%, then the machine learning model 140 can be described as sufficiently trained and the process 300 can end. This is illustrated at step 370. However, if the accuracy of the machine learning model 140 has not exceeded the predetermined threshold, then the training cycle repeats itself until the threshold is reached.

In some embodiments, the machine learning model 140 is trained based on a number of predetermined training cycles or epochs. For example, an administrator can set the training to fifty epochs. After each epoch, the accuracy of the machine learning model 140 increases. This can be evaluated based on the produced confidence scores relating to the log source type predictions and/or the event name predictions as well as during the validation process.

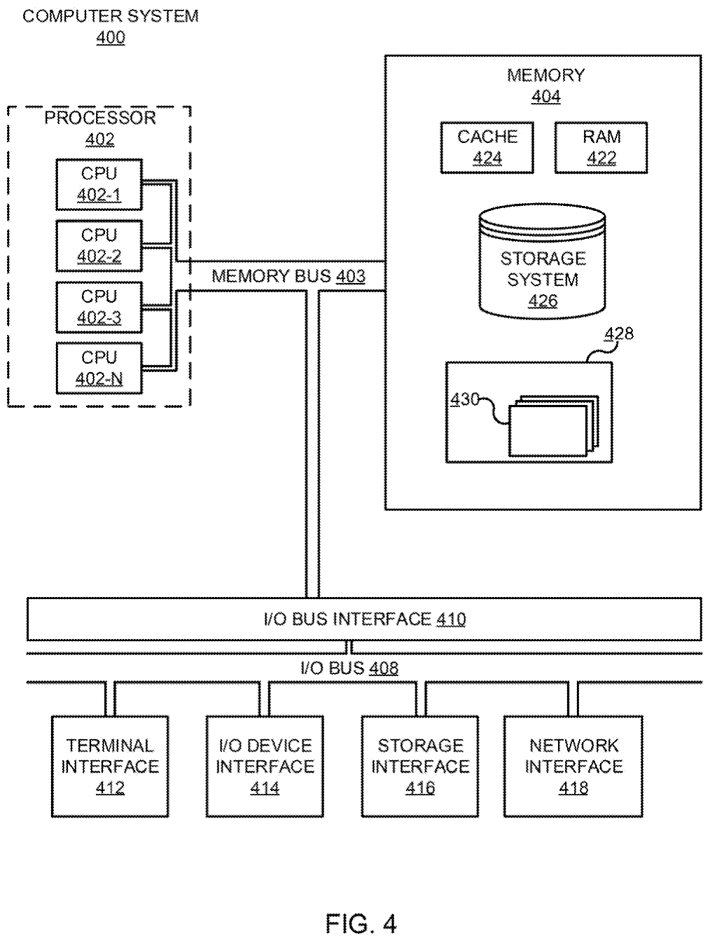

Referring now to FIG. 4, shown is a high-level block diagram of an example computer system 400 (e.g., the log classification system 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 400 may comprise one or more processors 402, a memory 404, a terminal interface 412, an I/O (Input/Output) device interface 414, a storage interface 416, and a network interface 418, all of which may be communicatively coupled, directly or indirectly, for inter-component communication via a memory bus 403, an I/O bus 408, and an I/O bus interface 410.

The computer system 400 may contain one or more general-purpose programmable central processing units (CPUs) 402-1, 402-2, 402-3, and 402-N, herein generically referred to as the processor 402. In some embodiments, the computer system 400 may contain multiple processors typical of a relatively large system; however, in other embodiments, the computer system 400 may alternatively be a single CPU system. Each processor 402 may execute instructions stored in the memory 404 and may include one or more levels of onboard cache.

The memory 404 may include computer system readable media in the form of volatile memory, such as random-access memory (RAM) 422 or cache memory 424. Computer system 400 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the processors 402, the memory 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 400 may, in some embodiments, contain multiple I/O bus interface units, multiple I/O buses, or both. Further, while multiple I/O interface units are shown, which separate the I/O bus 408 from various communications paths running to the various I/O devices, in other embodiments, some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the major representative components of an exemplary computer system 400. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 (e.g., the log classification system 100), may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and P.D.A.s).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

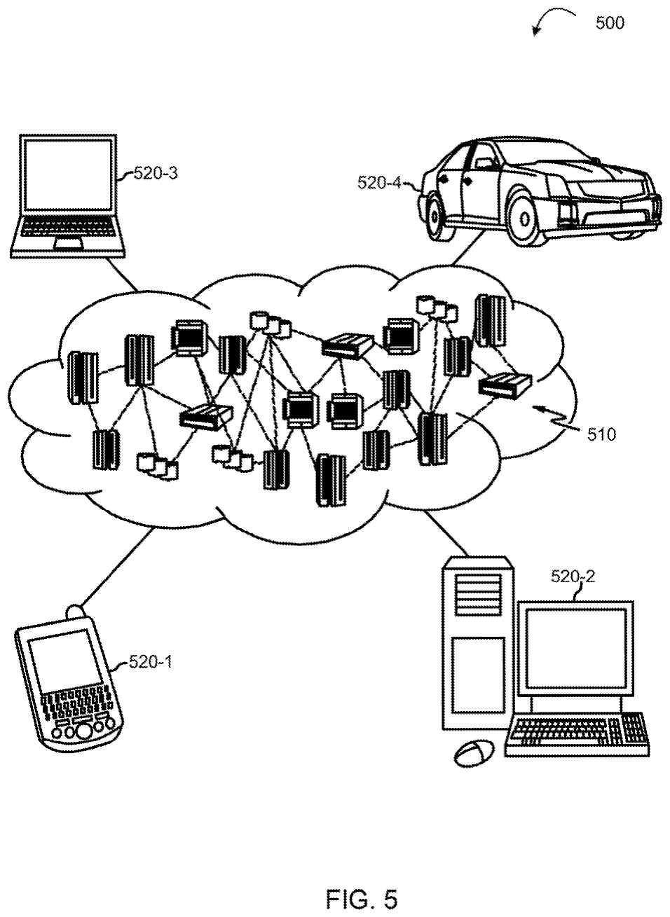

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (P.D.A.) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1 to 520-4 shown in FIG. 5 are intended to be illustrative only and that computing nodes 510 and cloud computing environment 500 can communicate with any type of computerized device over any type of network and/or network addressable connection (e.g., using a web browser).

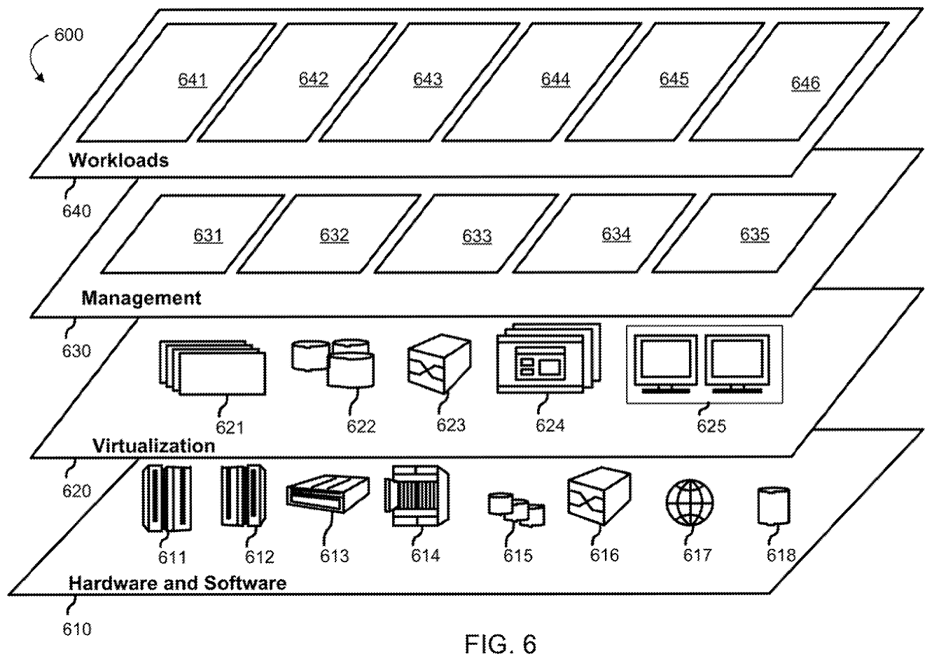

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 610 includes hardware and software components. Examples of hardware components include mainframes 611; RISC (Reduced Instruction Set Computer) architecture-based servers 612; servers 613; blade servers 614; storage devices 615; and networks and networking components 616. In some embodiments, software components include network application server software 617 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 may provide the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (S.L.A.) planning and fulfillment 635 provide pre-arrangement for, and procurement of, cloud computing resources for which a future requirement is anticipated in accordance with an S.L.A.

Workloads layer 640 provides examples of functionality for which the cloud computing environment may be utilized. Examples of workloads and functions which may be provided from this layer include mapping and navigation 641; software development and lifecycle management 642 (e.g., the log classification system 100); virtual classroom education delivery 643; data analytics processing 644; transaction processing 645; and precision cohort analytics 646.

The present disclosure may be a system, a method, and/or a computer program product at any possible technical detail level of integration. The computer program product may include a computer-readable storage medium (or media) having computer readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method of classifying unrecognized logs, the computer-implemented method comprising:
inputting a log unrecognized during event collection into a machine learning model, wherein the log relates to an event generated by a log source;
predicting, by the machine learning model, a log source type of the log to allow for normalization of the log;
producing, by the machine learning model, a confidence score relating to the source type prediction;
determining the confidence score exceeds a predetermined threshold; and
submitting the log for normalization based on the log source type prediction.

2. The computer-implemented method of claim 1, further comprising:
predicting, by the machine learning model, an event name relating to the log;
producing, by the machine learning model, a second confidence score relating to the event name prediction;
determining the second confidence score exceeds another predetermined threshold; and
submitting the log for normalization based on the log source type prediction and the event name prediction.

3. The computer-implemented method of claim 1, wherein the machine learning model is a one-dimensional convolutional neural network.

4. The computer-implemented method of claim 3, wherein the convolutional neural network recognizes word patterns within the log.

5. The computer-implemented method of claim 3, wherein the convolutional neural network is a six-layer network including three convolutional neural network (CNN) layers and two fully-connected layers, wherein the three CNN layers can each include both one-dimensional convolutions and sub-sampling pooling.

6. The computer-implemented method of claim 3, wherein the convolutional neural network is trained using historical logs stored by a log collector, wherein the historical logs are previously known logs stored by the log collector.

7. The computer-implemented method of claim 1, wherein the predetermined threshold is set by an administrator to allow for normalization of the log based on the confidence score achieving the predetermined threshold.

8. The computer-implemented method of claim 1, further comprising:
determining the confidence scores do not exceed the predetermined threshold;
marking the log as unparsed; and
alerting an administrator that the log is unparsed.

9. The computer-implemented method of claim 1, further comprising:
determining the log lacks available parsers based on the source type prediction; and
alerting an administrator that the log requires a new parser.

10. A computer-implemented method of training a convolutional neural network to identify logs, the computer-implemented method comprising:
selecting a plurality of historical logs from a log storage, wherein the historical logs are previously known logs stored by a log collector;
preprocessing the historical logs into a labeled dataset for a convolutional neural network;
separating the labeled dataset into a training dataset and a validation dataset;
training the convolutional neural network with the training dataset to output log source types for unrecognized logs including confidence scores relating to the log source types; and
validating log source type predictions made by the convolutional neural network using the validation dataset.

11. The computer-implemented method of claim 10, wherein preprocessing the historical logs comprises:
parsing each of the historical logs to separate words located within the historical logs;
tokenizing the words in the historical logs by converting the words into numbers;
padding each of the numbers with additional zeroes such that each of the numbers is of a same byte length; and
vectorizing the numbers to be inputted into the convolutional neural network.

12. The computer-implemented method of claim 10, wherein the convolutional neural network recognizes word patterns within the log.

13. The computer-implemented method of claim 10, wherein the convolutional neural network is a six-layer network including three convolutional neural network (CNN) layers and two fully-connected layers, wherein the three CNN layers can each include both one-dimensional convolutions and sub-sampling pooling.

14. A system of identifying logs, the system comprising:
a memory;
a processor;
a local data storage having stored thereon computer executable code;
a log storage configured to store log data including historical logs, wherein the historical logs are previously known logs;
an event collection module configured to identify and categorize logs;
a convolutional neural network configured to predict log source types relating to the logs unrecognized by the event collection module; and
a normalization component configured to apply parsers to normalize the identified logs.

15. The system of claim 14, wherein the convolutional neural network recognizes word patterns within the log.

16. The system of claim 14, wherein the convolutional neural network is a six-layer network including three convolutional neural network (CNN) layers and two fully-connected layers, wherein the three CNN layers can each include both one-dimensional convolutions and sub-sampling pooling.

17. The system of claim 14, wherein the convolutional neural network outputs confidence scores relating to the log source types, wherein the confidence scores reflect a decimal number between zero and one interpreting a percentage of confidence for each of the log source type outputs.

18. The system of claim 14, wherein the convolutional neural network is trained using the historical logs as training data.

19. The system of claim 14, wherein the convolutional neural network outputs event names relating to the logs.

20. The system of claim 19, wherein the convolutional neural network outputs additional confidence scores relating to the event names, wherein the additional confidence scores reflect a decimal number between zero and one interpreting a percentage of confidence for each of the log source type outputs.
